(19) United States
(12) Patent Application Publication
(10) Pub. No.: US 2023/0133212 A1
(43) Pub. Date: May 4, 2023

(54) ELECTROCOAGULATION SYSTEM

(71) Applicant: Curt Johnson, Casper, WY (US)

(72) Inventor: Curt Johnson, Casper, WY (US)

(21) Appl. No.: 17/985,574

(22) Filed: Nov. 11, 2022

Related U.S. Application Data
(63) Continuation-in-part of application No. 16/252,443, filed on Jan. 18, 2019, now Pat. No. 11,518,692.
(60) Provisional application No. 62/619,682, filed on Jan. 19, 2018.

(51) Int. Cl. C02F 1/461; C02F 1/463; C02F 1/00

(52) U.S. Cl. CPC C02F 1/46109; C02F 1/463; C02F 1/008; C02F 2303/16; C02F 2103/10

(57) ABSTRACT

An electrocoagulation (EC) unit that performs an electrocoagulation process on wastewater or the like. In one embodiment, the EC unit includes a reaction tank formed from a non-conductive material, charge plates within the reaction tank that are spaced at a distance, intermediate plates disposed within the reaction tank between the charge plates, and plate conductors configured to electrically couple the charge plates to a power source. The bottom of the reaction tank tapers toward one or more ports which act as an ingress and egress point for the EC unit.

### RELATED APPLICATIONS

This non-provisional patent application is a continuation-in-part of U.S. patent application Ser. No. 16/252,443 filed on Jan. 18, 2019, which is incorporated herein by reference.

### TECHNICAL FIELD

This disclosure is related to the field of water treatment systems, and more particularly, to electrocoagulation (EC) systems.

### BACKGROUND

Oil production industries and other industries are consistently forced to deal with water challenges that result from processes (i.e., drilling processes). During a drilling process, for example, an oil/water mixture is pumped from the ground, which is referred to as production water or wastewater. The wastewater coming from the ground could be 95% water and 5% oil by volume. The wastewater may also include traces of heavy metals and other contaminants. Before the wastewater can be safely disposed of or reused, the contaminants need to be removed. Thus, oil companies have the challenge of removing contaminants and safely disposing of the wastewater. Other companies in other industries face similar problems of having to safely dispose of wastewater.

One common way of treating wastewater is through a reverse osmosis filtering process. Unfortunately, the reverse osmosis filtering process is expensive and can be relatively slow especially when the contaminant content in the wastewater is high. Another common way of treating wastewater is through a distillation process, which again is expensive and time consuming. Yet another way of treating wastewater is through chemical processes, which are expensive and further processes are needed to return the wastewater to a safe level.

Thus, there is a need for improved filtering systems so that wastewater can be safely and reliably processed.

### SUMMARY

Embodiments described herein set forth an electrocoagulation (EC) unit for cleaning wastewater or the like. In one embodiment, an EC unit includes a reaction tank formed from a non-conductive material, charge plates within the reaction tank that are spaced at a distance, intermediate plates disposed within the reaction tank between the charge plates, and plate conductors configured to electrically couple the charge plates to a power source. The bottom of the reaction tank tapers toward one or more ports on the bottom of the reaction tank. Due to the tapered bottom, the reaction tank may be completely emptied or drained of liquids when desired, whether it be wastewater, sludge, a cleansing solution, etc.

In an embodiment, a method of cleaning an EC unit is disclosed comprising a reaction tank formed from a non-conductive material, and charge plates and intermediate plates disposed within the reaction tank. The method comprises initiating a cleaning cycle for the EC unit by stopping a flow of wastewater into a flush bottom port from an inlet tank fluidly coupled to the flush bottom port, where the flush bottom port is disposed at a lowest portion of the reaction tank in a gravity flow direction. The method further comprises draining the wastewater from the reaction tank through the flush bottom port to the inlet tank. The method further comprises filling the reaction tank, through the flush bottom port with a cleansing solution from a cleansing tank fluidly coupled to the flush bottom port, to at least an uppermost plate level of the charge plates and the intermediate plates. The method further comprises containing the cleansing solution in the reaction tank for a threshold time, and draining the cleansing solution from the reaction tank through the flush bottom port to the cleansing tank after the threshold time.

In an embodiment, the cleansing solution comprises an acid, such as hydrochloric acid.

In an embodiment, the cleaning cycle is initiated periodically.

In an embodiment, the cleaning cycle is initiated in a time range of four to six hours after an operation cycle of the EC unit.

In an embodiment, the reaction tank further comprises an overflow port through a side wall of the reaction tank between a water level of the EC unit and the uppermost plate level. The method further comprises producing a flow of the cleansing solution through the reaction tank and out of the overflow port during the cleaning cycle.

In an embodiment, a system comprises an EC unit comprising a reaction tank formed from a non-conductive material, charge plates and intermediate plates disposed within the reaction tank, and a flush bottom port disposed at a lowest portion of the reaction tank in a gravity flow direction. The system further comprises an inlet tank containing a wastewater fluidly coupled to the flush bottom port, and a cleansing tank containing a cleansing solution fluidly coupled to the flush bottom port. The system further comprises a controller configured to initiate a cleaning cycle for the EC unit by stopping a flow of the wastewater into the flush bottom port from the inlet tank, draining the wastewater from the reaction tank through the flush bottom port to the inlet tank, filling the reaction tank, through the flush bottom port with the cleansing solution from the cleansing tank, to at least an uppermost plate level of the charge plates and the intermediate plates, containing the cleansing solution in the reaction tank for a threshold time, and draining the cleansing solution from the reaction tank through the flush bottom port to the cleansing tank after the threshold time.

In an embodiment, the cleansing solution comprises an acid, such as hydrochloric acid.

In an embodiment, the controller is configured to initiate the cleaning cycle periodically.

In an embodiment, the controller is configured to initiate the cleaning cycle in a time range of four to six hours after an operation cycle of the EC unit.

In an embodiment, the reaction tank further comprises an overflow port through a side wall of the reaction tank between a water level of the EC unit and the uppermost plate level. The controller is configured to produce a flow of the cleansing solution through the flush bottom port that flows out of the overflow port during the cleaning cycle.

In an embodiment, the flush bottom port disposed at the lowest portion of the reaction tank in the gravity flow direction comprises a first flush bottom port fluidly coupled to the inlet tank, and a second flush bottom port fluidly coupled to the cleansing tank.

In an embodiment, the reaction tank is cylindrical.

In an embodiment, a bottom section of the reaction tank, that includes the flush bottom port, is conical.

In an embodiment, a system comprises an EC unit comprising a reaction tank comprising an upper section and a lower section formed from a non-conductive material, and charge plates and intermediate plates disposed within the upper section of the reaction tank. The lower section is funnel-shaped with a flush bottom port disposed at a lowest portion of the reaction tank in a gravity flow direction. The system further comprises an inlet tank containing a wastewater fluidly coupled to the flush bottom port, and a cleansing tank containing a cleansing solution fluidly coupled to the flush bottom port. The system further comprises a controller configured to initiate a cleaning cycle for the EC unit by stopping a flow of the wastewater into the flush bottom port from the inlet tank, draining the wastewater from the reaction tank through the flush bottom port to the inlet tank, filling the reaction tank, through the flush bottom port with the cleansing solution from the cleansing tank, to at least an uppermost plate level of the charge plates and the intermediate plates, containing the cleansing solution in the reaction tank for a threshold time, and draining the cleansing solution from the reaction tank through the flush bottom port to the cleansing tank after the threshold time.

In an embodiment, the cleansing solution comprises an acid, such as hydrochloric acid.

In an embodiment, the controller is configured to initiate the cleaning cycle periodically.

In an embodiment, the lower section of the reaction tank is conical.

The above summary provides a basic understanding of some aspects of the specification. This summary is not an extensive overview of the specification. It is intended to neither identify key or critical elements of the specification nor delineate any scope of the particular embodiments of the specification, or any scope of the claims. Its sole purpose is to present some concepts of the specification in a simplified form as a prelude to the more detailed description that is presented later.

### DESCRIPTION OF THE DRAWINGS

Some embodiments of the invention are now described, by way of example only, and with reference to the accompanying drawings. The same reference number represents the same element or the same type of element on all drawings.

FIG. 1 illustrates a water filtering system in an illustrative embodiment.

FIG. 2 is a perspective view of an EC unit in an illustrative embodiment.

FIG. 3 is a cross-sectional view of a reaction tank in an illustrative embodiment.

FIG. 4 is a top view of a reaction tank in an illustrative embodiment.

FIG. 5 is a perspective diagram of charge plates and intermediate plates in an illustrative embodiment.

FIGS. 6-7 illustrate an electrical connection for a charge plate in an illustrative embodiment.

FIG. 8 is a perspective view of a charge plate in an illustrative embodiment.

FIG. 9 is a cross-sectional view of a lower section of a reaction tank in an illustrative embodiment.

FIG. 10 is a cross-sectional view of a lower section of a reaction tank in another illustrative embodiment.

FIG. 11 is a perspective view of an EC unit with a cylindrical reaction tank in an illustrative embodiment.

FIG. 12 is a flow chart illustrating a method of processing wastewater in an illustrative embodiment.

FIG. 13 is a flow chart illustrating a clean cycle in an illustrative embodiment.

FIG. 14 is a cross-sectional view of a lower section of a reaction tank in an illustrative embodiment.

### DESCRIPTION OF EMBODIMENTS

The figures and the following description illustrate specific exemplary embodiments. It will thus be appreciated that those skilled in the art will be able to devise various arrangements that, although not explicitly described or shown herein, embody the principles of the embodiments and are included within the scope of the embodiments. Furthermore, any examples described herein are intended to aid in understanding the principles of the embodiments, and are to be construed as being without limitation to such specifically recited examples and conditions. As a result, the inventive concept(s) is not limited to the specific embodiments or examples described below, but by the claims and their equivalents.

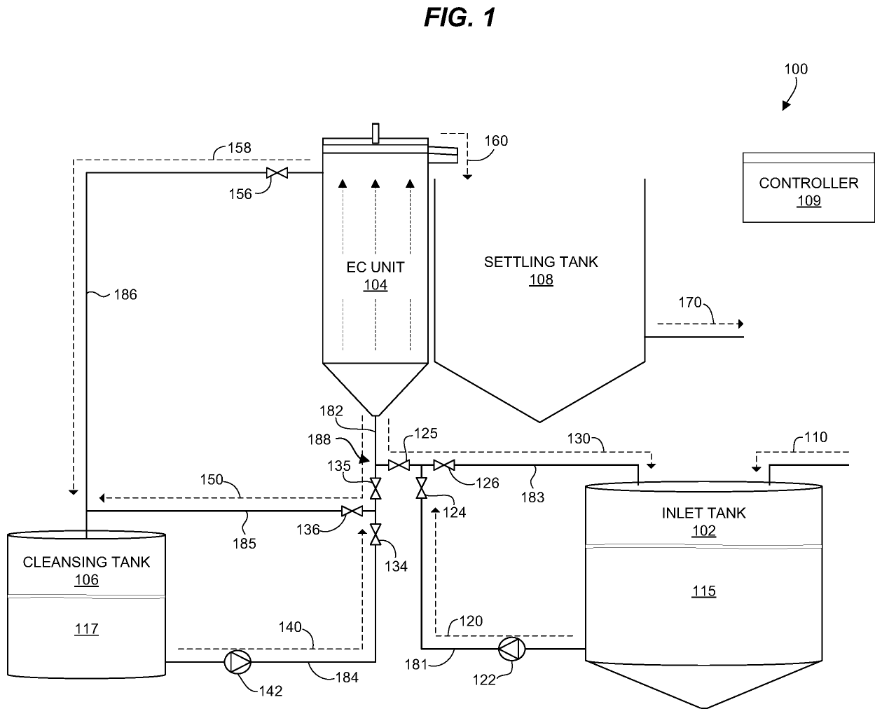

FIG. 1 illustrates a water filtering system 100 in an illustrative embodiment. Water filtering system 100 may be used as one of multiple stages for filtering wastewater, which comprises water that includes one or more contaminants. Wastewater may also be referred to as grey water or production water. In one example, wastewater is produced during oil drilling processes.

Water filtering system 100 includes one or more inlet tanks 102, one or more EC units 104, one or more cleansing tanks 106, and one or more settling tanks 108. An inlet tank 102 is a receptacle or storage chamber that stores or contains wastewater to be filtered or purified. An EC unit 104 (also referred to as an EC cell or EC system) comprises a system that uses electrocoagulation to separate suspended particles from a liquid. A cleansing tank 106 comprises a receptacle or storage chamber that stores or contains a cleansing solution for EC unit 104, such as an acid. A settling tank 108 (also referred to as a receiving tank or a clarifier) is a receptacle or storage chamber that stores or contains wastewater after electrocoagulation. The EC unit(s) 104 of water filtering system 100 are elevated in relation to inlet tank 102 and cleansing tank 106 so that fluids in the EC unit(s) may drain via gravity into inlet tank 102 or cleansing tank 106.

In this embodiment, inlet tank 102 is supplied with wastewater 115 via a supply fluid path 110. Inlet tank 102 is fluidly coupled to EC unit 104 via an inlet fluid path 120 (also referred to as a supply fluid path). Inlet fluid path 120 may include a pump 122, valves 124-125, supply piping 181, and common piping 182 that fluidly connect inlet tank 102 with EC unit 104. Pump 122 is configured to force wastewater 115 from inlet tank 102 to EC unit 104 via inlet fluid path 120 when valves 124-125 are open. Inlet tank 102 is also fluidly coupled to EC unit 104 via a drain fluid path 130. Drain fluid path 130 may include valves 125-126, common piping 182, and drain piping 183 that fluidly connect EC unit 104 and inlet tank 102. Wastewater 115 from EC unit 104 is configured to gravity drain into inlet tank 102 via drain fluid path 130 when valves 125-126 are open.

Cleansing tank 106 is fluidly coupled to EC unit 104 via an inlet fluid path 140 (also referred to as a supply fluid path). Inlet fluid path 140 may include a pump 142, valves 134-135, supply piping 184, and common piping 182 that fluidly connect cleansing tank 106 with EC unit 104. Pump 142 is configured to force a cleansing solution 117 from cleansing tank 106 to EC unit 104 via inlet fluid path 140 when valves 134-135 are open. A cleansing solution 117 comprises a liquid configured to clean EC unit 104, or more particularly plates of EC unit 104, such as an acid, hydrochloric acid, etc. Cleansing tank 106 is also fluidly coupled to EC unit 104 via a drain fluid path 150. Drain fluid path 150 may include valves 135-136, common piping 182, and drain piping 185 that fluidly connect EC unit 104 and cleansing tank 106. Cleansing tank 106 is also fluidly coupled to EC unit 104 via an overflow fluid path 158. Overflow fluid path 158 may include a valve 156 and drain piping 186 that fluidly connects EC unit 104 and cleansing tank 106.

The configuration for inlet fluid path 120, drain fluid path 130, inlet fluid path 140, and drain fluid path 150 are examples, and other configurations as considered herein. For example, a tee pipe 188 is illustrated between common piping 182 and each of inlet fluid path 120 and drain fluid path 130, and inlet fluid path 140 and drain fluid path 150. However, other plumbing configurations are considered herein.

Settling tank 108 is disposed near an outlet of EC unit 104, and is fluidly coupled to EC unit 104 via an outlet fluid path 160. As described in more detail below, wastewater 115 may be gravity fed from the outlet at or near the top of EC unit 104 to settling tank 108 via outlet fluid path 160. Clean or purified water may be released from settling tank 108 via outlet path 170.

Water filtering system 100 may further include a controller 109 configured to provide automated and/or computerized control of water filtering system 100. Controller 109 is configured to regulate the opening and closing of various valves 124-126, 134-136, and 156 throughout water filtering system 100, to control pumps 122 and 142, to control power to various components, such as EC unit 104, etc. Controller 109 may include one or more processors that are communicatively coupled to a memory. While the specific hardware implementation of controller 109 is subject to design choices to perform the functionality described herein, the processor may comprise any electronic circuits and/or optical circuits that are able to perform functions. The processor may include one or more Central Processing Units (CPU), microprocessors, Digital Signal Processors (DSPs), Application-specific Integrated Circuits (ASICs), Programmable Logic Devices (PLD), control circuitry, etc. Some examples of processors include INTEL® CORE™ processors, Advanced Reduced Instruction Set Computing (RISC) Machines (ARM®) processors, etc. The memory comprises any electronic circuits, and/or optical circuits, and/or magnetic circuits that are able to store data. The memory may include one or more volatile or non-volatile Dynamic Random-Access Memory (DRAM) devices, FLASH devices, volatile or non-volatile Static RAM devices, magnetic disk drives, Solid State Disks (SSDs), etc. Some examples of non-volatile DRAM and SRAM include battery-backed DRAM and battery-backed SRAM.

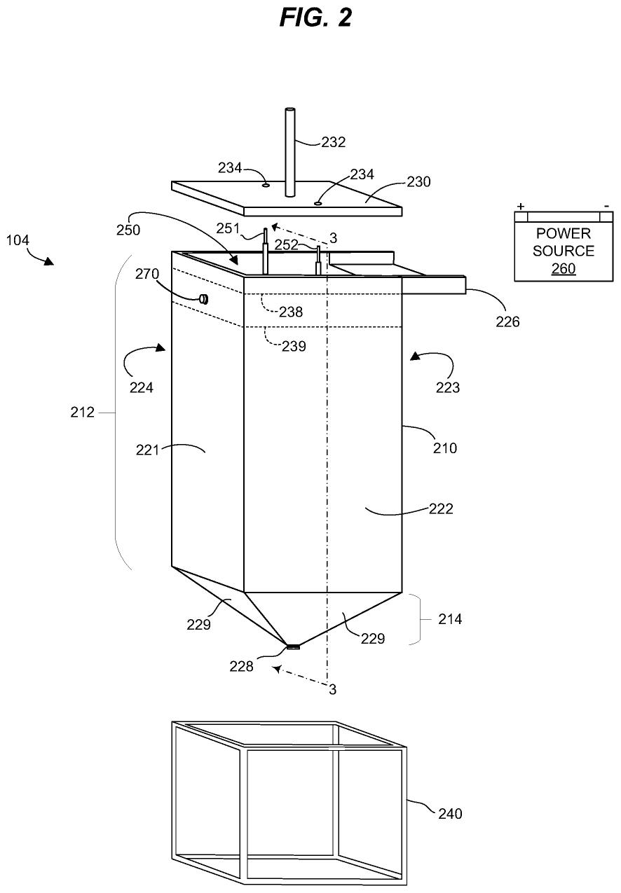

FIG. 2 is a perspective view of EC unit 104 in an illustrative embodiment. Electrocoagulation is a technique used to treat wastewater to remove contaminants, such as ion particles, colloidal particles, etc. Contaminants are particles in wastewater that are generally held in the solution by electrical charges. Electrostatic repulsion of the particles inhibits the particles from coagulating in the wastewater. Electrocoagulation is a process that reduces the surface charges of the particles to a point where the particles are destabilized and can form an agglomeration. As will be described in more detail below, EC unit 104 includes an electrocoagulation reactor having a positively-charged electrode (an anode) and a negatively-charged electrode (a cathode) connected to an external power source. As wastewater 115 flows through EC unit 104, a potential is placed across the electrodes by the power source, which injects a current through the wastewater 115. The positive side undergoes anodic reactions while the negative side undergoes cathodic reactions. Consumable metal plates, such as iron or aluminum, are usually used as sacrificial electrodes to continuously produce ions in the wastewater 115. The released ions neutralize the charges on the particles in the wastewater 115 and thereby initiate coagulation. As a result, the reactive and excited state causes the contaminant particles to coagulate, and be released from the wastewater 115.

EC unit 104 includes a reaction tank 210 or tub, which is a receptacle or storage chamber configured to contain wastewater 115 that is being processed. Reaction tank 210 includes an upper section 212 and a lower section 214 that are formed from a non-conductive material, such as Polyvinyl Chloride (PVC), polyethylene, polypropylene, or another type of plastic, fiberglass, etc. In this embodiment, upper section 212 is square or rectangular with side walls 221-224. Further in this embodiment, side walls 221-224 may generally be twice as tall as they are wide.

Lower section 214 tapers from upper section 212 to one or more ports 228 on the bottom of reaction tank 210 to form a funnel or hopper shape. Lower section 214 has one or more sloped walls 229 that join along a top edge to upper section 212, and converge at a bottom edge at or near port 228. Lower section 214 may be conical, wedge, pyramidal, or a combination of these shapes. The funnel shape of lower section 214 acts to concentrate liquid materials at port 228 when discharged from reaction tank 210. Port 228 is a mouth or opening disposed at the bottom (i.e., lowest portion) of reaction tank 210 in the gravity flow direction, which acts as an ingress and/or egress point for liquid materials. Thus, port 228 is an inlet port for liquid materials, and an outlet port.

When in operation, wastewater 115 flows upward through EC unit 104 from port 228 and out of the top of reaction tank 210. Therefore, reaction tank 210 includes a trough 226 at its top. Trough 226 comprises an opening(s), channel, conduit, etc., at or near the top of reaction tank 210 that acts as an exit point for wastewater 115 to flow out of EC unit 104. Trough 226 may have any desired structural design to convey wastewater 115 out of EC unit 104 and to settling tank 108 (see FIG. 1). Because trough 226 is the exit point for wastewater 115, the vertical position of trough 226 alongside wall 223 defines a water level 238 for EC unit 104. Trough 226 is shown on side wall 223 in this embodiment, but may be on other side walls in other embodiments. Also, side wall 221 is shown with an overflow port 270 through side wall 221 that is situated below the water level 238.

Although not visible in FIG. 2, EC unit 104 includes a series of plates (or blades) installed in the interior 250 of reaction tank 210 that are configured to conduct a current through wastewater 115 that flows through reaction tank 210. The plates include a pair of charge plates that connect to a power source 260. One of the charge plates is a positively-charged electrode, and the other charge plate is a negatively-charged electrode. A plate conductor 251 for one of the charge plates, and a plate conductor 252 for the other charge plate are visible extending out of reaction tank 210. The plates also include one or more intermediate plates that are aligned between the charge plates within reaction tank 210, as will be described in more detail below. The top of one or more of the charge plates and the intermediate plates define an uppermost plate level 239, which is below water level 238. Overflow port 270 is disposed between uppermost plate level 239 and water level 238.

EC unit 104 may further include a lid 230 that covers the top of reaction tank 210. During processing of wastewater 115, noxious gasses may be emitted from EC unit 104. Lid 230 acts to contain gas emissions from EC unit 104. Lid 230 may include a vent 232 that guides gases from the interior 250 of EC unit 104 to a more distant location. Lid 230 may further include plate conductor openings 234 that act as passageways for plate conductors 251-252 and insulators that surround plate conductors 251-252. Plate conductors 251-252 may therefore connect to a power source 260 outside of reaction tank 210. The power connection may be housed in a sealed chamber for safety of the operator and to protect the power connection from corrosion.

The EC unit 104 may further include a support framework 240 configured to hold reaction tank 210 in an upright position.

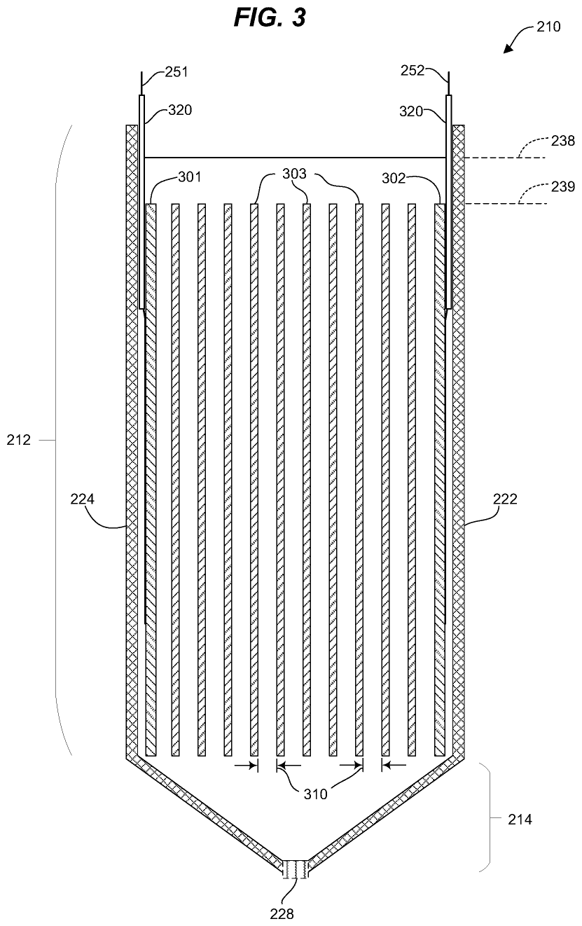

FIG. 3 is a cross-sectional view of reaction tank 210 in an illustrative embodiment. The view in FIG. 3 is across cut-plane 3-3 in FIG. 2, and shows an electrocoagulation reactor having charge plates 301-302 that are spaced at a distance. A charge plate is a sheet of metallic material, such as iron, aluminum, etc. Charge plates 301-302 are disposed at or near opposite side walls of reaction tank 210 within upper section 212. Plate conductor 251 is configured to connect with one terminal of power source 260 (see FIG. 2), and plate conductor 252 is configured to connect with the other terminal of power source 260. An insulator 320 is disposed around plate conductors 251-252 from below water level 238 to above water level 238. Insulator 320 comprises any sleeve, sheath, covering, casing, coating, etc., made from a non-conductive material that is configured to electrically isolate at least a length of a plate conductor 251-252. Insulator 320 may extend from above water level 238 to an electrical coupling (e.g., a weld) between a charge plate 301-302 and a plate conductor 251-252.

The electrocoagulation reactor further includes one or more intermediate plates 303 or neutral plates disposed between charge plates 301-302. Intermediate plates 303 are not directly connected to power source 260. Intermediate plates 303 are spaced between charge plates 301-302 to improve current flow through the wastewater 115 within reaction tank 210. In one embodiment, charge plates 301-302 may be oriented vertically and parallel to one another. Intermediate plates 303 may also be oriented vertically, and parallel to one another and to charge plates 301-302. Intermediate plates 303 are installed within reaction tank 210 so that there are gaps 310 between opposing faces of charge plates 301-302 and intermediate plates 303. For example, the gap 310 may be in the range of ⅛^{th} inch to ⅜^{th} inch, such as 5/16^{th} inch spacing between opposing faces. Gaps 310 form conduits for wastewater 115 to flow upward between plates 301-303. It may be desirable for gap 310 to be substantially constant or uniform along the entire length and width of the plates to avoid physical contact between the plates. The tops of charge plates 301-302 and intermediate plates 303 may be co-planar, and the bottoms of charge plates 301-302 and intermediate plates 303 may be coplanar as shown in FIG. 3. The tops of charge plates 301-302 and intermediate plates 303 are positioned below water level 238 defined by trough 226. It may be desirable for the space between water level 238 and the tops of charge plates 301-302/intermediate plates 303 to be minimal to avoid a current path between charge plates 301-302 that traverses above intermediate plates 303. At the same time, the space between water level 238 and the tops of charge plates 301-302/intermediate plates 303 is large enough to accommodate overflow port 270.

In other embodiments, charge plates 301-302 and intermediate plates 303 may be oriented at a slight angle relative to vertical, with a gap 310 between the plates.

In other embodiments, charge plates 301-302 and intermediate plates 303 may be staggered in the vertical direction so that the tops and bottoms of charge plates 301-302 and intermediate plates 303 are not coplanar.

Assume in an operational example that a potential is placed across plate conductors 251-252 by power source 260 with wastewater 115 in reaction tank 210, where charge plate 301 acts as the anode (+) and charge plate 302 acts as the cathode (−). When this occurs, current is injected into plate conductor 251 and into charge plate 301. The current passes through the wastewater 115 and intermediate plates 303, into charge plate 302, and along plate conductor 252. The current is therefore dispersed through the wastewater 115 as the wastewater 115 traverses upward through reaction tank 210, to neutralize charges on the particles in the wastewater.

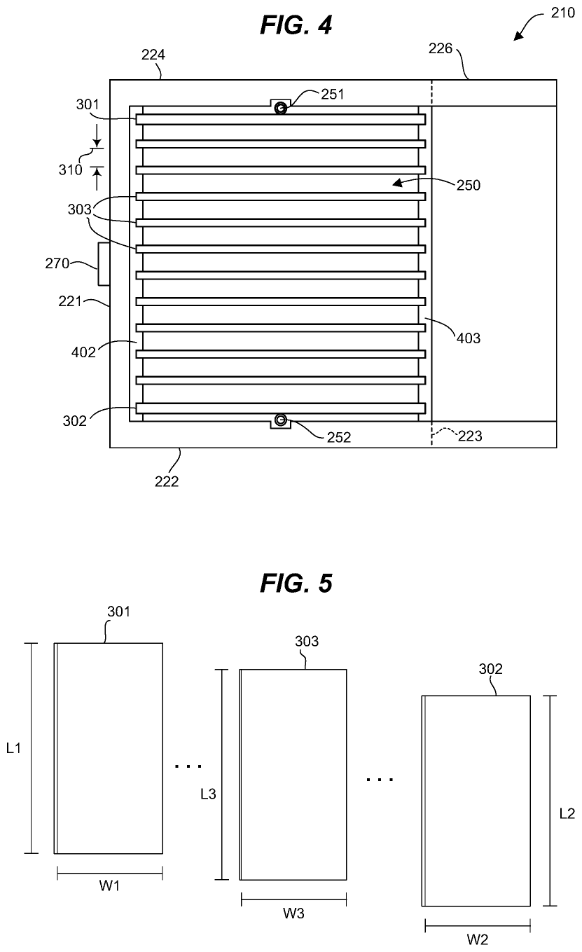

FIG. 4 is a top or plan view of reaction tank 210 in an illustrative embodiment. In this figure, lid 230 is removed to expose the interior 250 of reaction tank 210. Reaction tank 210 may include a mounting rack 402 disposed at or near side wall 221 of reaction tank 210, and a mounting rack 403 disposed at or near side wall 223 of reaction tank 210. Charge plate 301 is slid into mounting racks 402-403 proximate to side wall 224 of reaction tank 210, and charge plate 302 is slid into mounting racks 402-403 proximate to side wall 222 of reaction tank 210. Intermediate plates 303 are slid into mounting racks 402-403 between charge plates 301-302. In this view, charge plates 301-302 and intermediate plates 303 are oriented substantially vertical within reaction tank 210, with a gap 310 between the plates. FIG. 4 also shows trough 226 projecting outward from side wall 223 of reaction tank 210.

FIG. 5 is a perspective view of charge plates 301-302 and intermediate plates 303 in an illustrative embodiment. In this embodiment, charge plates 301-302 and intermediate plates 303 are rectangular in shape. Charge plate 301 has a length L1 (or height) in the vertical direction, and a width W1 in the horizontal direction. Charge plate 302 has a length L2 in the vertical direction, and a width W2 in the horizontal direction. Intermediate plates 303 have a length L3 in the vertical direction, and a width W3 in the horizontal direction. The shape and/or area charge plates 301-302 may be the same or substantially the same, and the shape and/or area of intermediate plates 303 may be the same or substantially the same as charge plates 301-302.

In one embodiment, the length of the plates 301-303 may be at least twice the width of plates 301-303. As the wastewater 115 flows upward through reaction tank 210, plates 301-303 that are longer than they are wide allows for longer residence or contact time between the wastewater 115 and the electrical current. For example, the residence time may be about 90 seconds, which makes the electrocoagulation process more effective. Additionally or alternatively, charge plates 301-302 may be at least twice as thick as intermediate plates 303.

In other embodiments, plates 301-303 may have shapes that are non-rectangular. Also, the length and width of the plates 301-303 may differ as desired.

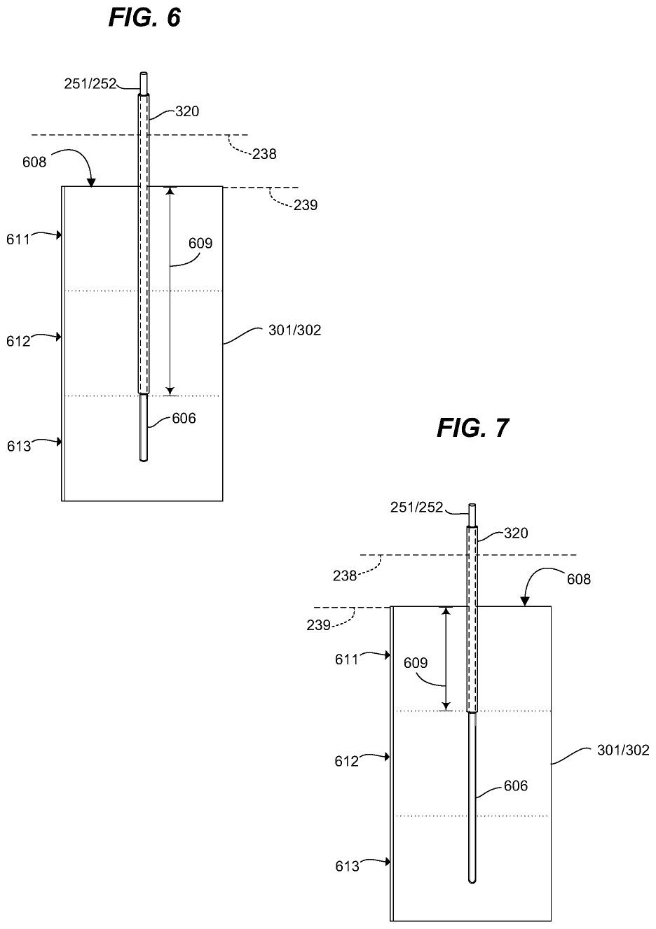

FIGS. 6-7 illustrate an electrical connection for a charge plate 301-302 in an illustrative embodiment. Charge plate 301/302 connects to power source 260 through a plate conductor 251/252 (see also, FIG. 2). Plate conductor 251/252 is a length of conductive material, such as a wire or rod (e.g., round or flat), that connects to charge plate 301/302 and extends out of reaction tank 210. Plate conductor 251/252 may be formed from the same material as charge plate 301/302. In FIG. 6, plate conductor 251/252 extends down along a side of charge plate 301/302, and makes an electrical connection with charge plate 301/302 at or near the bottom of charge plate 301/302 denoted by electrical coupling 606. Electrical coupling 606 represents a point where plate conductor 251/252 and charge plate 301/302 are joined. Electrical coupling 606 may comprise a weld or welded joint, a brazed joint, a fastened joint (e.g., bolts, screws, rivets, etc.), or another type of joint.

In the embodiments described herein, electrical coupling 606 is disposed a distance 609 from a top 608 of charge plate 301/302. In one embodiment, distance 609 may be at least three inches below a top 608 of charge plate 301/302 or a top of an intermediate plate 303 in the vertical direction. By moving electrical coupling 606 down from the top 608 of charge plate 301-302, current is injected toward the center or bottom of charge plate 301/302 and is not concentrated toward the top 608 of charge plate 301/302. The area of charge plate 301/302 may be divided into a top region 611, a middle region 612, and a bottom region 613. In the embodiment shown in FIG. 6, electrical coupling 606 of plate conductor 251/252 with charge plate 301/302 is located at bottom region 613. In the embodiment shown in FIG. 7, electrical coupling 606 of plate conductor 251/252 with charge plate 301/302 is located at middle region 612 and bottom region 613. In yet another embodiment, electrical coupling 606 of plate conductor 251/252 with charge plate 301/302 may be partially at top region 611, middle region 612, and/or bottom region 613.

Plate conductor 251/252 is wrapped, covered, or encased by insulator 320 from above water level 238 of EC unit 104 to electrical coupling 606. Insulator 320 may extend into or out of plate conductor openings 234 in lid 230 (see FIG. 2). Insulator 320 electrically isolates plate conductor 251/252 from charge plate 301/302 except along electrical coupling 606. Insulator 320 allows current to be injected into a charge plate 301-302 below the surface of the wastewater 115 in reaction tank 210. Some benefits of injecting current below the surface of the wastewater 115 are to mitigate or eliminate current spread across the top of intermediate plates 303, and to mitigate or eliminate deterioration of plate conductors 251-252 at the surface of the wastewater 115.

FIG. 8 is a perspective view of a charge plate 301-302 in an illustrative embodiment. In this embodiment, a charge plate 301-302 and plate conductor 251-252 comprise a monolithic body formed, cast, stamped, etc., as a single piece. Charge plate 301-302 includes a recess 802 at the top 608 that extends downward. Plate conductor 251-252 projects out of top 608 of charge plate 301/302 from recess 802. Insulator 320 surrounds plate conductor 251-252 from below the top 608 of charge plate 301-302 to above the water level 238.

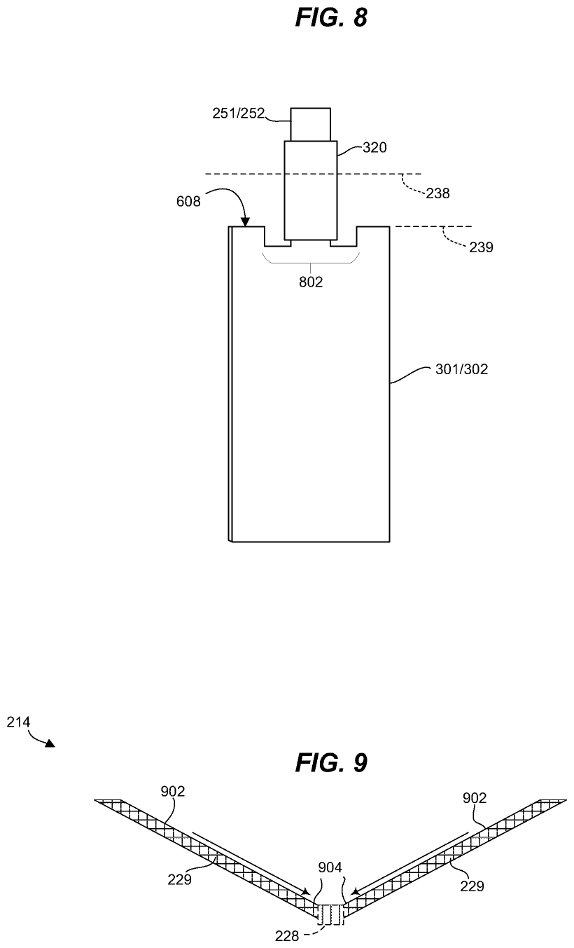

FIG. 9 is a cross-sectional view of lower section 214 of reaction tank 210 in an illustrative embodiment. As described above, side walls 229 of lower section 214 converge at port 228 to form a funnel shape. Side walls 229 have interior surfaces 902 that slope toward and abut port 228 at a bottom end 904. In this embodiment, the bottom ends 904 of interior surfaces 902 are flush with port 228 to form a smooth transition between interior surfaces 902 and port 228. Port 228 may therefore be referred to as a “flush” bottom port disposed at a lowest portion of reaction tank 210 (i.e., the inside of reaction tank 210) in a gravity flow direction (i.e., downward in FIG. 9). The term “flush” refers to a generally continuous plane or generally unbroken surface. In other words, there is no lip or other protrusion between interior surfaces 902 and port 228. This is beneficial in that liquid materials (e.g., wastewater, sludge, cleansing solution, etc.) are able to freely flow out of port 228 without obstruction so that reaction tank 210 can be completely or fully drained.

In an alternative embodiment, there may be more than one port 228 at the bottom of lower section 214. For example, there may be one port 228 for wastewater 115, and a separate port for the cleansing solution 117. FIG. 14 is a cross-sectional view of lower section 214 of reaction tank 210 in an illustrative embodiment. In this embodiment, port 228 includes a wastewater port 228-1 and a cleansing solution port 228-2. Each of ports 228-1 and 228-2 are flush with interior surfaces 902 of side walls 229. Wastewater port 228-1 may be fluidly coupled with inlet fluid path 120 and drain fluid path 130 as illustrated in FIG. 1. Likewise, cleansing solution port 228-2 may be fluidly coupled with inlet fluid path 140 and drain fluid path 150 as illustrated in FIG. 1. Thus, tee pipe 188 and common piping 182 as shown in FIG. 1 would not be used.

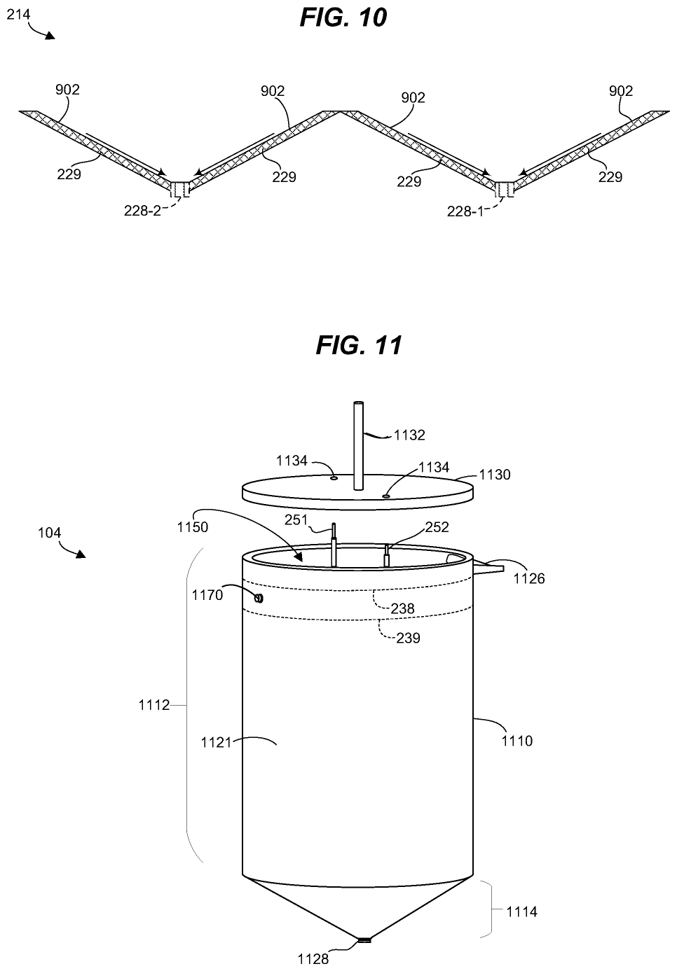

In the embodiments shown above, reaction tank 210 has a single funnel structure that discharges at one or more ports 228. In other embodiments, reaction tank 210 may have multiple funnel structures that discharge at one or more ports 228. FIG. 10 is a cross-sectional view of lower section 214 of reaction tank 210 in another illustrative embodiment. In this embodiment, lower section 214 includes two funnel structures. The side walls 229 of lower section 214 converge at two distinct ports 228 (e.g., wastewater port 228-1 and cleansing solution port 228-2). The embodiment in FIG. 10 is just one example, and lower section 214 may have more than two funnel structures in other embodiments.

The shape of reaction tank 210 for EC unit 104 shown in the above embodiments is square or rectangular. However, the reaction tank may have other shapes in other embodiments. FIG. 11 is a perspective view of an EC unit 104 with a cylindrical reaction tank in an illustrative embodiment. Reaction tank 1110 includes an upper section 1112 and a lower section 1114 that are formed from a non-conductive material. In this embodiment, upper section 1112 has a cylindrical side wall 1121. Lower section 1114 tapers from upper section 1112 to one or more ports 1128 (e.g., flush bottom port) on the bottom of reaction tank 1110 to form a funnel shape. Lower section 1114 has a conical shape that joins along a top edge to upper section 1112, and converges at a bottom edge at or near port 1128.

When in operation, wastewater 115 flows upward through EC unit 104 from port 1128 and out of the top of reaction tank 1110. Therefore, reaction tank 1110 includes a trough 1126 at its top. Trough 1126 may have any desired structural design to convey wastewater 115 out of EC unit 104 and to a settling tank 108 (see FIG. 1). Although not visible in FIG. 11, EC unit 104 includes a pair of charge plates installed in the interior 1150 of reaction tank 1110 that connect to a power source, and one or more intermediate plates that are aligned between the charge plates within reaction tank 1110. Trough 1126 is disposed above the top of the charge plates and the intermediate plates. Because trough 1126 is the exit point for wastewater, the vertical position of trough 1126 alongside wall 1121 defines a water level 238 for EC unit 104. Also, side wall 1121 is shown with an overflow port 1170 that is situated below the water level 238, and above the uppermost plate level 239.

EC unit 104 may further include a lid 1130 that covers the top of reaction tank 1110. Lid 1130 may include a vent 1132 that guides gases from the interior 1150 of EC unit 104 to a more distant location. Lid 1130 may further include plate conductor openings 1134 that act as passageways for plate conductors 251-252, and insulators that surround plate conductors 251-252.

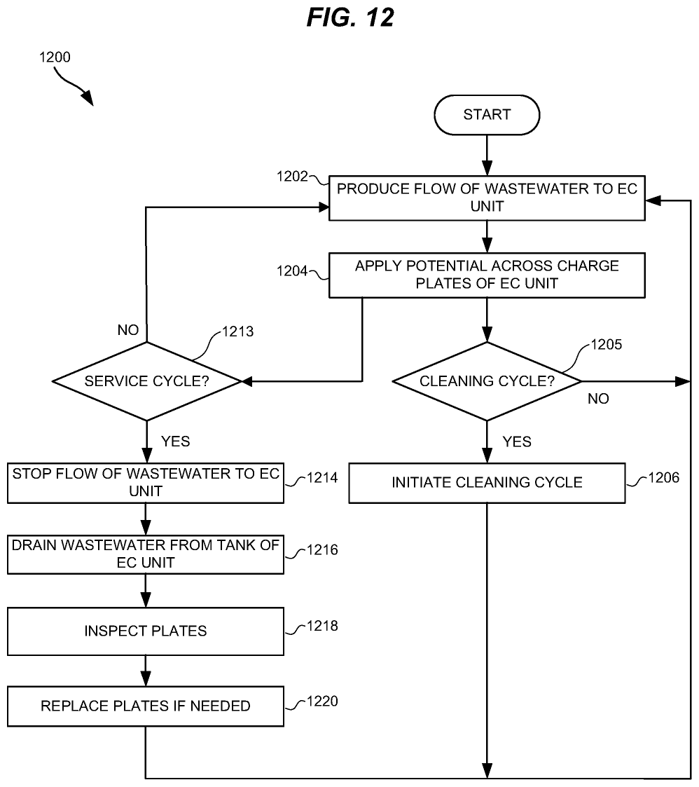

FIG. 12 is a flow chart illustrating a method 1200 of processing wastewater 115 in an illustrative embodiment. The steps of method 1200 will be described with reference to water filtering system 100 in FIG. 1 and EC unit 104 in FIGS. 2-4, but those skilled in the art will appreciate that method 1200 may be performed in other systems or devices. Also, the steps of the flow charts described herein are not all inclusive and may include other steps not shown, and the steps may be performed in an alternative order.

When in operation (i.e., in operation time or operation cycle), controller 109 produces a flow of wastewater 115 from inlet tank 102 to one or more EC units 104 (step 1202). There may be multiple EC units 104 operating in parallel based on the flow requirements of water filtering system 100. Thus, controller 109 may select which of the EC units 104 are active at any point in time, and produce a flow of wastewater 115 to the selected EC unit(s) 104. To supply wastewater 115 to an EC unit 104, controller 109 opens valves 124-125 and activates pump 122 to produce a flow of wastewater 115 along inlet fluid path 120 to EC unit 104 through port 228. Controller 109 controls power source 260 to apply a potential across charge plates 301-302 of EC unit 104 (step 1204). As EC unit 104 receives the flow of wastewater 115 from its bottom, the wastewater 115 flows upward within reaction tank 210 between the charge plates 301-302 and intermediate plates 303. As the wastewater 115 flows between the charge plates 301-302 and intermediate plates 303, the potential placed across the charge plates 301-302 injects a current through the wastewater 115. The positive charge plate 301/302 undergoes anodic reactions while the negative charge plate 301/302 undergoes cathodic reactions, which continuously produces ions in the wastewater 115. The released ions neutralize the charges on the particles in the wastewater 115 and thereby initiate coagulation. Controller 109 may control power source 260 to reverse polarity across charge plates 301-302 periodically (e.g., every 20 seconds) to avoid oxidation or scaling on one side of charge plates 301-302 and intermediate plates 303. Controller 109 may also adjust the potential placed across charge plates 301-302 based on condition of the wastewater 115, condition of plates 301-303, or other factors.

The wastewater 115 flows out of trough 226 at the top of reaction tank 210, and is gravity-fed into settling tank 108 along outlet fluid path 160 where the wastewater 115 is temporarily stored. As the wastewater 115 sits in settling tank 108, the neutralized particles in the wastewater 115 separate from the wastewater 115 and fall to the bottom of settling tank 108. The particles that are released from the wastewater 115 form a slurry of solids on the bottom of settling tank 108, while the filtered water remains as a liquid on top of the slurry. The filtered water may be released from settling tank 108 via outlet path 170.

Controller 109 determines whether to initiate a cleaning cycle for an EC unit 104 (step 1205). Charge plates 301-302 and intermediate plates 303 may become coated with a non-conducting oxide, which may cause the electrocoagulation process to fail through reduced efficiency and increased power consumption. Controller 109 may initiate or perform the cleaning cycle (step 1206) periodically (e.g., after a time range of about four to six hours of runtime of the operation cycle, after a time range of about six to twelve hours, or another time range) to remove the oxide or scaling that form on the plates 301-303 of the EC unit 104. If multiple EC units 104 are running in parallel, controller 109 may select one or more EC units 104 for a cleaning cycle while other EC units 104 stay in operation.

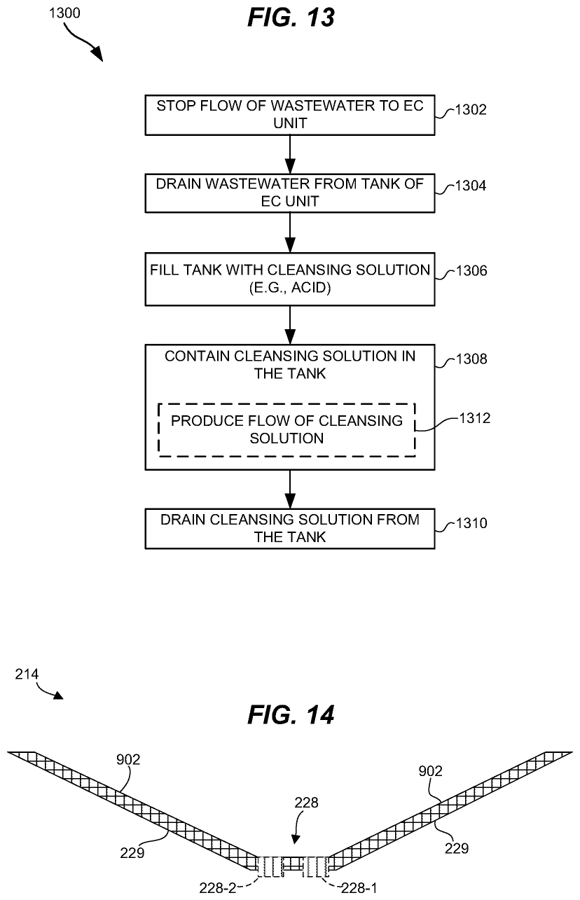

FIG. 13 is a flow chart illustrating a clean cycle 1300 in an illustrative embodiment. When a cleaning cycle is initiated for an EC unit 104, controller 109 stops the flow of wastewater 115 to the selected EC unit 104 through port 228 (step 1302). To do so, controller 109 may deactivate pump 122 and close valve 124 to stop the flow of wastewater 115 along inlet fluid path 120. Controller 109 then drains the wastewater 115 (and any remaining sludge) from reaction tank 210 of EC unit 104 through port 228 (step 1304). To drain reaction tank 210, controller 109 may open valve 126 and the liquid remaining in reaction tank 210 discharges along drain fluid path 130 to inlet tank 102 via gravity flow. The liquid remaining in reaction tank 210 is generally a slurry comprised of wastewater 115 and a sludge that forms in the lower section 214 of reaction tank 210. Due to the funnel shape of lower section 214 of reaction tank 210, the slurry is able to fully evacuate from reaction tank 210 along drain fluid path 130, including any sludge that forms in reaction tank 210. Thus, an operator does not need to remove lid 230 and scrape the sludge from reaction tank 210.

With reaction tank 210 emptied of wastewater 115, controller 109 may close valves 124-126. Controller 109 then fills the reaction tank 210 of the EC unit 104 with a cleansing solution 117 from cleansing tank 106 through port 228 (step 1306). To do so, controller 109 may open valves 134-135, and activate pump 142 to produce a flow of cleansing solution 117 along inlet fluid path 140 to EC unit 104. As EC unit 104 receives the flow of cleansing solution 117 from its bottom, the cleansing solution 117 flows upward within reaction tank 210 between the charge plates 301-302 and intermediate plates 303. In one embodiment, controller 109 may stop the flow of cleansing solution 117 at or above the uppermost plate level 239 (see FIG. 2), or between the uppermost plate level 239 and the water level 238. For example, controller 109 may stop pump 142 and close valve 134 when the cleansing solution 117 fills reaction tank 210 at least to the uppermost plate level 239. It may be desirable for the plates 301-303 of the EC unit 104 to be fully submerged in the cleaning solution 117. The cleansing solution 117 acts to remove oxide or scaling on charge plates 301-302 and intermediate plates 303. Thus, controller 109 may wait for a configurable time period or threshold time, such as 30 seconds, 60 seconds, 90 seconds, etc., while reaction tank 210 contains the cleansing solution 117 with the plates 301-303 exposed or soaking in the cleaning solution 117 (step 1308). Thus, the cleaning cycle may be referred to as a soaking cycle.

In one embodiment, the cleansing solution 117 may flow through reaction tank 210 during the cleaning cycle. Thus, controller 109 may produce a flow of the cleansing solution 117 through reaction tank 210 and out of overflow port 270 during the cleaning cycle (optional step 1312). The flow of the cleansing solution 117 may be used during, after, or in place of a soaking cycle.

At the end of the cleaning cycle 1300, controller 109 drains the cleansing solution 117 from reaction tank 210 through port 228 after the threshold time (step 1310). To do so, controller 109 may open valve 136 and the cleansing solution 117 in reaction tank 210 discharges along drain fluid path 150 back to cleansing tank 106 via gravity flow. After the cleaning cycle, controller 109 may close valves 135-136, and put EC unit 104 back into operation (i.e., an operation cycle).

Controller 109 may also determine whether to initiate a service cycle for an EC unit 104 (step 1213). As stated above, charge plates 301-302 and intermediate plates 303 may be coated with a non-conducting oxide, which may cause the electrocoagulation process to fail through reduced efficiency and increased power consumption. Also, charge plates 301-302 and intermediate plates 303 are sacrificial and will corrode during the electrocoagulation process. The service cycle is performed to determine whether one or more of the charge plates 301-302 and intermediate plates 303 need to be serviced or replaced. If multiple EC units 104 are running in parallel, controller 109 may select one or more EC units 104 for a service cycle while other EC units 104 stay in operation.

When a service cycle is initiated for an EC unit 104, controller 109 stops the flow of wastewater 115 to the selected EC unit 104 (step 1214). To do so, controller 109 may deactivate pump 122 and closes valve 124 to stop the flow of wastewater 115 along inlet fluid path 120. Controller 109 then drains the wastewater 115 from reaction tank 210 of EC unit 104 through port 228 (step 1216). To drain reaction tank 210, controller 109 may open valve 126 and the liquid remaining in reaction tank 210 discharges along drain fluid path 130 to inlet tank 102 via gravity flow.

With reaction tank 210 emptied, controller 109 may control a sensor (not shown) or another type of element to inspect charge plates 301-302 and intermediate plates 303 (step 1218). Alternatively, an operator may remove lid 230 to visually inspect charge plates 301-302 and intermediate plates 303. One or more of charge plates 301-302 and intermediate plates 303 may be replaced (step 1220) as needed. After the service cycle, controller 109 may put EC unit 104 back into operation.

Although specific embodiments were described herein, the scope of the disclosure is not limited to those specific embodiments. The scope of the disclosure is defined by the following claims and any equivalents thereof.

What is claimed is:

1. A method of cleaning an Electrocoagulation (EC) unit comprising a reaction tank formed from a non-conductive material, and charge plates and intermediate plates disposed within the reaction tank, the method comprising:
initiating a cleaning cycle for the EC unit by:
stopping a flow of wastewater into a flush bottom port from an inlet tank fluidly coupled to the flush bottom port, wherein the flush bottom port is disposed at a lowest portion of the reaction tank in a gravity flow direction;
draining the wastewater from the reaction tank through the flush bottom port to the inlet tank;
filling the reaction tank, through the flush bottom port with a cleansing solution from a cleansing tank fluidly coupled to the flush bottom port, to at least an uppermost plate level of the charge plates and the intermediate plates;
containing the cleansing solution in the reaction tank for a threshold time; and
draining the cleansing solution from the reaction tank through the flush bottom port to the cleansing tank after the threshold time.

2. The method of claim 1 wherein:
the cleansing solution comprises an acid.

3. The method of claim 1 wherein:
the cleansing solution comprises a hydrochloric acid.

4. The method of claim 1 wherein:
the cleaning cycle is initiated periodically.

5. The method of claim 4 wherein:
the cleaning cycle is initiated in a time range of six to twelve hours after an operation cycle of the EC unit.

6. The method of claim 1 wherein the reaction tank further comprises an overflow port through a side wall of the reaction tank between a water level of the EC unit and the uppermost plate level, the method further comprising:
producing a flow of the cleansing solution through the reaction tank and out of the overflow port during the cleaning cycle.

7. A system comprising:
an Electrocoagulation (EC) unit comprising:
a reaction tank formed from a non-conductive material;
charge plates and intermediate plates disposed within the reaction tank; and
a flush bottom port disposed at a lowest portion of the reaction tank in a gravity flow direction;
an inlet tank containing a wastewater fluidly coupled to the flush bottom port;
a cleansing tank containing a cleansing solution fluidly coupled to the flush bottom port; and
a controller configured to initiate a cleaning cycle for the EC unit by:
stopping a flow of the wastewater into the flush bottom port from the inlet tank;
draining the wastewater from the reaction tank through the flush bottom port to the inlet tank;
filling the reaction tank, through the flush bottom port with the cleansing solution from the cleansing tank, to at least an uppermost plate level of the charge plates and the intermediate plates;
containing the cleansing solution in the reaction tank for a threshold time; and
draining the cleansing solution from the reaction tank through the flush bottom port to the cleansing tank after the threshold time.

8. The system of claim 7 wherein:
the cleansing solution comprises an acid.

9. The system of claim 7 wherein:
the cleansing solution comprises a hydrochloric acid.

10. The system of claim 7 wherein:
the controller is configured to initiate the cleaning cycle periodically.

11. The system of claim 10 wherein:
the controller is configured to initiate the cleaning cycle in a time range of six to twelve hours after an operation cycle of the EC unit.

12. The system of claim 7 wherein:
the reaction tank further comprises an overflow port through a side wall of the reaction tank between a water level of the EC unit and the uppermost plate level; and
the controller is configured to produce a flow of the cleansing solution through the flush bottom port that flows out of the overflow port during the cleaning cycle.

13. The system of claim 7 wherein:
the flush bottom port disposed at the lowest portion of the reaction tank in the gravity flow direction comprises:
a first flush bottom port fluidly coupled to the inlet tank; and
a second flush bottom port fluidly coupled to the cleansing tank.

14. The system of claim 7 wherein:
the reaction tank is cylindrical.

15. The system of claim 14 wherein:
a bottom section of the reaction tank, that includes the flush bottom port, is conical.

16. A system comprising:
an Electrocoagulation (EC) unit comprising:
a reaction tank comprising an upper section and a lower section formed from a non-conductive material; and
charge plates and intermediate plates disposed within the upper section of the reaction tank;
wherein the lower section is funnel-shaped with a flush bottom port disposed at a lowest portion of the reaction tank in a gravity flow direction;
an inlet tank containing a wastewater fluidly coupled to the flush bottom port;
a cleansing tank containing a cleansing solution fluidly coupled to the flush bottom port; and
a controller configured to initiate a cleaning cycle for the EC unit by:
stopping a flow of the wastewater into the flush bottom port from the inlet tank;
draining the wastewater from the reaction tank through the flush bottom port to the inlet tank;
filling the reaction tank, through the flush bottom port with the cleansing solution from the cleansing tank, to at least an uppermost plate level of the charge plates and the intermediate plates;
containing the cleansing solution in the reaction tank for a threshold time; and
draining the cleansing solution from the reaction tank through the flush bottom port to the cleansing tank after the threshold time.

17. The system of claim 16 wherein:
the cleansing solution comprises an acid.

18. The system of claim 16 wherein:
the cleansing solution comprises a hydrochloric acid.

19. The system of claim 16 wherein:
the controller is configured to initiate the cleaning cycle periodically.

20. The system of claim 16 wherein:
the lower section of the reaction tank is conical.
